(19) United States
(12) Patent Application Publication
(10) Pub. No.: US 2015/0220097 A1
(43) Pub. Date: Aug. 6, 2015

(54) SYSTEM AND METHOD FOR JUST-IN-TIME LEARNING-BASED PREDICTIVE THERMAL MITIGATION IN A PORTABLE COMPUTING DEVICE

(71) Applicant: QUALCOMM INCORPORATED, San Diego, CA (US)

(72) Inventors: Tung Chuen Kwong, Richmond Hill (CA); Dariusz Krolikowski, Mississauga (CA); Wilson Hung Yu, Markham (CA); Fan Peng Kong, Richmond Hill (CA)

(73) Assignee: QUALCOMM INCORPORATED, San Diego, CA (US)

(21) Appl. No.: 14/172,763

(22) Filed: Feb. 4, 2014

(51) Int. Cl. G05F 1/66; G06N 99/00

(52) U.S. Cl. CPC G05F 1/66; G06N 99/005

(57) ABSTRACT

Various embodiments of methods and systems for just-in-time learning-based predictive thermal management (“JLPTM”) techniques implemented in a portable computing device (“PCD”) are disclosed. Embodiments of JLPTM systems and methods recognize that multiple thermal aggressors affect temperature readings of individual temperature sensors and that thermal events measured by those sensors may be predicted based on historical thermal behavior of the PCD. By monitoring various factors that contribute to thermal energy generation and/or dissipation in the PCD, JLPTM systems and methods may predict thermal events from historical thermal behavior data, identify optimum performance level settings combinations that will reduce thermal energy generation, and set a time in the future to apply an optimum performance level settings combination just-in-time to prevent the thermal event from occurring.

### DESCRIPTION OF THE RELATED ART

Portable computing devices (“PCDs”) are typically limited in size and, therefore, room for components within a PCD often comes at a premium. As such, there usually isn't enough space within a PCD for engineers and designers to mitigate thermal degradation or failure of processing components by using clever spatial arrangements or strategic placement of passive cooling components. Therefore, certain systems and methods rely on various temperature sensors embedded on the PCD chip to monitor the dissipation of thermal energy.

Because the temperature sensors are mapped to one or more processing components, their measurements may be used to trigger application of thermal management techniques for those processing components. In this way, current systems and methods rely on temperature measurements to exceed predetermined thermal thresholds in order to trigger a thermal mitigation decision. Once the need for thermal mitigation is triggered by a temperature measurement that has exceeded a thermal threshold, current systems and methods use mathematical models to determine the appropriate thermal mitigation decision. The thermal mitigation decision is then applied immediately so that thermal energy generation is mitigated. Current systems and methods for thermal mitigation may continue in their application of mitigation decisions until the temperature measurement is reduced below the threshold and the alert cleared, at the expense of quality of service (“QoS”) delivered to the user.

Because current systems and methods for thermal mitigation are triggered by a temperature reading that exceeds a predetermined threshold, the predetermined thresholds must be set at a temperature that is well below a temperature at which thermal degradation of processing components is a reality. Consequently, current systems and methods determine and apply thermal mitigation decisions in a reactive manner that unnecessarily affects QoS before a critical thermal event occurs, or even under the assumption that a thermal event might occur. Notably, because the predetermined thresholds are necessarily set at precautionary levels, current systems and methods for thermal mitigation are predicated upon the assumption that a critical thermal event is inevitable once the alert threshold is exceeded.

Because any number of factors other than a temperature exceeding a precautionary threshold must be in place for a critical thermal event to occur (i.e., for a critical thermal level to be reached that may thermally degrade or compromise the health of one or more components within the PCD), current systems and methods may prematurely apply thermal mitigation decisions at the expense of optimizing QoS to a user. Therefore, what is needed in the art is a system and method for just-in-time learning-based predictive thermal management (“JLPTM”). More specifically, what is needed in the art is a system and method that learns the thermal characteristics of a PCD such that it may predict the timing of an inevitable thermal event if all factors in the PCD are held constant, and then apply a thermal mitigation decision just-in-time to prevent the predicted thermal event from occurring.

### SUMMARY OF THE DISCLOSURE

Various embodiments of methods and systems for just-in-time learning-based predictive thermal management (“JLPTM”) techniques implemented in a portable computing device (“PCD”) are disclosed. Notably, in many PCDs, thermal energy levels measured by individual temperature sensors in the PCD may be attributable to a plurality of processing components, i.e. thermal aggressors. Generally, as more power is consumed by the various processing components, the resulting generation of thermal energy may cause the temperature thresholds associated with temperature sensors located around the chip to be exceeded, thereby necessitating that the performance of the PCD be sacrificed in an effort to reduce thermal energy generation.

Advantageously, embodiments of JLPTM systems and methods recognize that multiple thermal aggressors affect temperature readings of individual temperature sensors and that thermal events measured by those sensors may be predicted based on historical thermal behavior of the PCD. By monitoring various factors that contribute to thermal energy generation and/or dissipation in the PCD, JLPTM systems and methods may predict thermal events from historical thermal behavior data, identify optimum performance level settings combinations that will reduce thermal energy generation, and set a time in the future to apply an optimum performance level settings combination just-in-time to prevent the thermal event from occurring.

An exemplary embodiment of JLPTM method monitors a combination of thermal factors in the PCD, wherein each thermal factor contributes to a pattern of thermal behavior in the PCD. Recognizing that a value associated with one or more of the thermal factors in the combination has changed, resulting in a modified combination of thermal factors, a JLPTM method queries a database of historical thermal behavior data associated with the modified combination of thermal factors. From the historical thermal behavior data, the method may predict that a thermal event will occur if the particular modified combination of thermal factors remains unchanged. Consequently, the method identifies from the query an optimal bin setting combination for one or more thermal aggressors in the PCD that, if applied to the one or more thermal aggressors, will mitigate thermal energy generation. Instead of immediately applying the optimal bin setting combination, however, the method uses the historical data to determine how long it may wait to apply the optimal bin setting combination and still avoid the thermal event. The method may then set a timer, the expiration of which will trigger application of the optimal bin setting combination.

By using historical thermal behavior data, a JLPTM system and method may be proactive in its thermal management approach. Performance levels of thermal aggressors are only modified just-in-time to avoid the thermal event, thereby allowing the processing components (i.e., the thermal aggressors) to run at preferred performance levels for as long as possible before adjusting the performance level settings to mitigate thermal energy generation. In this way, a JLPTM system and method optimizes QoS to the user while proactively avoiding predicted thermal events from occurring.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is an illustration of exemplary thermal dynamics between multiple thermal aggressors and multiple temperature sensors in a system on a chip (“SOC”);

FIG. 2 is a functional block diagram illustrating an embodiment of an on-chip system for implementing just-in-time learning-based predictive thermal management (“JLPTM”) methodologies in a PCD;

FIG. 3 is a functional block diagram illustrating an exemplary, non-limiting aspect of the PCD of FIG. 2 in the form of a wireless telephone for implementing methods and systems for just-in-time learning-based predictive thermal management (“JLPTM”);

FIG. 4A is a functional block diagram illustrating an exemplary spatial arrangement of hardware for the chip illustrated in FIG. 3;

FIG. 4B is a schematic diagram illustrating an exemplary software architecture of the PCD of FIG. 3 for just-in-time learning-based predictive thermal management (“JLPTM”);

FIGS. 5A-5B are a logical flowchart illustrating a method for managing thermal energy generation in the PCD of FIG. 2 through multi-correlative learning of the thermal dynamics between multiple thermal aggressors and multiple temperature sensors;

FIG. 6 is a logical flowchart illustrating a sub-method or subroutine 526 for an initial full iterative learning of the multi-correlative thermal dynamics between multiple thermal aggressors and multiple temperature sensors in association with a given thermal factor combination; and

FIG. 7 is a logical flowchart illustrating a sub-method or subroutine 528 for an additional incremental iterative learning of the multi-correlative thermal dynamics between multiple thermal aggressors and multiple temperature sensors in association with a given target temperature.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein may also include files that are not executable in nature, such as documents that may need to be opened or other data files that need to be accessed.

As used in this description, the terms “component,” “database,” “module,” “system,” “thermal energy generating component,” “processing component,” “thermal aggressor” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or a chip may be comprised of one or more distinct processing components generally referred to herein as “core(s).” Additionally, to the extent that a CPU, DSP, GPU, chip or core is a functional component within a PCD that consumes various levels of power to operate at various levels of functional efficiency, one of ordinary skill in the art will recognize that the use of these terms does not limit the application of the disclosed embodiments, or their equivalents, to the context of processing components within a PCD. That is, although many of the embodiments are described in the context of a processing component, it is envisioned that multi-correlative learning thermal management policies may be applied to any functional component within a PCD including, but not limited to, a modem, a camera, a wireless network interface controller (“WNIC”), a display, a video encoder, a peripheral device, a battery, etc.

Further to that which is defined above, a “processing component” or “thermal energy generating component” or “thermal aggressor” may be, but is not limited to, a central processing unit, a graphical processing unit, a core, a main core, a sub-core, a processing area, a hardware engine, etc. or any component residing within, or external to, an integrated circuit within a portable computing device. Moreover, to the extent that the terms “thermal load,” “thermal distribution,” “thermal signature,” “thermal footprint,” “thermal dynamics,” “thermal processing load” and the like are indicative of workload burdens that may be running on a processor, one of ordinary skill in the art will acknowledge that use of these “thermal” terms in the present disclosure may be related to process load distributions, workload burdens and power consumption.

In this description, it will be understood that the terms “thermal” and “thermal energy” may be used in association with a device or component capable of generating or dissipating energy that can be measured in units of “temperature.” Moreover, it will be understood that the terms “thermal footprint,” “thermal dynamics” and the like may be used within the context of the thermal relationship between two or more components within a PCD and may be quantifiable in units of temperature. Consequently, it will further be understood that the term “temperature,” with reference to some standard value, envisions any measurement that may be indicative of the relative warmth, or absence of heat, of a “thermal energy” generating device or the thermal relationship between components. For example, the “temperature” of two components is the same when the two components are in “thermal” equilibrium.

In this description, the terms “thermal mitigation technique(s),” “thermal policies,” “thermal management,” “thermal mitigation measure(s),” “throttling to a performance level,” “thermal mitigation decision” and the like are used interchangeably. Notably, one of ordinary skill in the art will recognize that, depending on the particular context of use, any of the terms listed in this paragraph may serve to describe hardware and/or software operable to increase performance at the expense of thermal energy generation, decrease thermal energy generation at the expense of performance, or alternate between such goals.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

In this description, the terms “performance setting,” “bin setting,” “power level” and the like are used interchangeably to reference the power level supplied to a thermally aggressive processing device.

In this description, “thermal factor” is meant to refer to any component or measured condition that affects thermal energy levels in the PCD. As such, a thermal factor may be associated with an increase in thermal energy, a decrease in thermal energy, or both. Thermal factors are envisioned to include, but are not limited to including, processor performance settings, ambient temperature, workload levels, etc. Changes in any one or more thermal factors may cause a PCD to experience a thermal event such as exceeding a critical temperature threshold.

Managing thermal energy generation in a PCD, without unnecessarily impacting quality of service (“QoS”), may be accomplished by leveraging one or more sensor measurements that each indicate thermal energy generated by, and dissipated from, one or more thermal aggressors. By closely monitoring the temperatures of thermal sensors located strategically around a chip, and mapping those temperatures over time to other thermal factors known to affect thermal energy generation, a just-in-time learning-based predictive thermal management (“JLPTM”) module in a PCD may predict thermal events based on state changes in those thermal factors. The JLPTM module may subsequently identify optimum combinations of performance levels for a group of thermally aggressive processing components that collectively contribute to the temperatures measured by the thermal sensors and delay application of those optimum combinations until absolutely required to avoid the predicted thermal event.

A JLPTM embodiment may map the temperature readings over time to any number of thermal factors including, but not limited to, device settings, ambient temperatures, use cases, workload changes, changes in thermal energy dissipation behavior, etc. Consequently, a JLPTM embodiment may recognize the state of any one or more of the thermal factors and predict a thermal event (such as a critical temperature threshold being exceeded) should the state(s) remain unchanged. Knowing the timing of the thermal event, a JLPTM embodiment may set a timer for application of new device settings that would alter the thermal energy generation by thermal aggressors in the PCD, thereby allowing the PCD to continue running at its preferred performance level for as long as possible before applying the device setting adjustments. In this way, a JLPTM system and method provides for the PCD to deliver an optimum QoS to its user and only sacrifices that QoS via new device settings when occurrence of the predicted thermal event becomes inevitable.

Notably, a JLPTM system and method uses state changes in one or more of the thermal factors to trigger prediction of future thermal events. If, based on the states of the thermal factors, historical data previously collected by the JLPTM system indicates that a thermal event will occur at a certain time in the future, mitigation measures in the form of adjusted device settings are determined and a time set for application of those adjusted device settings. If the states of one or more of the thermal factors change before the time arrives to apply the adjusted device settings, the probability of a future thermal event is reevaluated. Based on the reevaluation, the mitigation decision previously determined and set for application at a future time may be canceled. Alternatively, based on the reevaluation, a new combination of adjusted device settings, and a time to apply them, may be determined and set.

To develop a historical pattern of thermal behavior in the PCD, for a given target temperature of a thermal sensor the JLPTM module may cause the power levels supplied to the thermal aggressors to be incremented up and down systematically, one device and one bin at a time, in an effort to find valid combinations of bin settings that will prevent thermal energy generation in excess of the target temperature. The time required for a given bin setting combination to be in effect before it completes its impact on thermal energy generation and dissipation in the PCD is also recorded. The valid combinations of bin settings may be stored in association with measurements of various thermal factors such as, but not limited to, ambient temperature, workload levels, etc. In view of the thermal factors, the transitional time required for the valid combinations to mitigate thermal energy generation to such an extent that the target temperature is not reached may also be noted by the JLPTM module. In developing the historical pattern of thermal behavior for the PCD, the JLPTM may also deduce the temperature of the ambient environment to which the PCD is exposed.

Advantageously, with knowledge of the states of the various thermal factors, in application the JLPTM module may predict a future thermal event and determine an optimal time at which one of the learned combinations of bin settings may be applied across all the thermal aggressors in order to avoid the thermal event from occurring. Additionally, and as one of ordinary skill in the art will recognize, because JLPTM methods may be applied without regard for the specific mechanics of thermal energy dissipation in a given PCD under a given workload, engineers and designers may employ a JLPTM approach without consideration of a PCD's particular form factor.

Notably, although exemplary embodiments of JLPTM methods are described herein in the context of a central processing unit (“CPU”) and a graphical processing unit (“GPU”), application of JLPTM methodologies are not limited to a CPU and/or GPU combination of thermal aggressors. It is envisioned that JLPTM methods may be extended to any combination of thermal aggressors and thermal sensors that may exist within a system on a chip (“SoC”). For ease of explanation, some of the illustrations in this specification primarily include just a pair of thermal sensors which may detect a thermal event caused by the collective thermal contribution from a pair of thermal aggressors in the form of a CPU and GPU; however, it will be understood that any number of thermal aggressors and thermal sensors may be the subject of a JLPTM policy.

As a non-limiting example of how a JLPTM approach to developing a historical pattern of thermal behavior may be applied to a family of thermal aggressors in an exemplary PCD, assume that a discrete number of bin settings, i.e. performance levels, P1, P2, P3, P4 . . . P15 (where P15 represents a maximum performance level and P1 represents a lowest performance level) have been defined for each of a pair of thermal aggressors. As one of ordinary skill in the art would understand, level P15 may be associated with both a high QoS level and a high thermal energy generation level for a given workload burden. Similarly, for the same workload burden, level P1 may be associated with both a low QoS level and a low thermal energy generation level. Assume also that a thermal event temperature for a given temperature sensor, Sensor 1, has been set at 60° C.

In the non-limiting example, the JLPTM embodiment may use a multi-correlative learning algorithm to develop knowledge of the PCD's thermal behavior relative to the Sensor 1 temperature reading and various thermal factors. Once a new set of thermal factor states are recognized, a JLPTM module may identify previously learned combinations of performance settings for the thermal aggressors which, if applied, would cause the temperature reading to fall and stabilize below the thermal event temperature (assuming that the ambient temperature to which the PCD is exposed and other thermal factor settings are substantially unchanged from when the settings combinations were learned). Based on the multi-correlation between the active aggressors' bin settings and the valid bin settings' combinations in the thermal settings database, together with the resulting temperature's relative closeness to the thermal event temperature, the JLPTM embodiment may select an optimum bin setting combination that is best suited for the use case and then cause the active performance settings of the thermal aggressors to be modified to the selected optimum bin setting combination just-in-time to avoid the thermal event.

Returning to the example, if an optimum bin setting combination has not been previously learned by the JLPTM module for the combination of thermal factor states and the 60° C. thermal event temperature, the JLPTM module may seek an optimum bin setting combination. The initial mitigation table used by the JLPTM module for Sensor 1 may indicate that the bin settings for Thermal Aggressor 1 and Thermal Aggressor 2 should be set at the lowest bin level for each target temperature, including the exemplary 60° C. thermal event temperature (the Default Mitigation Table for Sensor 1). As such, when any one of those target temperatures is exceeded for the first time, the JLPTM module will reference the mitigation table and see that the bin setting combination for the thermal aggressors includes each being set to the minimum bin setting. The JLPTM module may then cause the active bin settings for both of Thermal Aggressors 1 and 2 to be changed to its minimum bin setting, thus substantially reducing, if not eliminating, all thermal energy being generated by the thermal aggressors. Consequently, the temperature measured by the sensor may begin to drop and, if the bin settings remain at the minimum settings, stabilize at a temperature that is substantially in equilibrium with the ambient environment temperature of the PCD.

As the temperature measured by Sensor 1 drops, a heat dissipation curve may be mapped by the JLPTM module (time versus temperature). Similarly, as the temperature measured by other temperature sensors also drops, a heat dissipation curve associated with each of those sensors may also be mapped. From the heat dissipation curves, the JLPTM module may be able to estimate in future applications how long it will take a given sensor to reach any target temperature, assuming the ambient temperature is consistent with the ambient temperature at the time of developing the heat dissipation curve and the bin settings for each thermal aggressor were set to minimum levels. For illustrative purposes, a default mitigation table associated with the given sensor and used by the JLPTM module in this example may be:

Default Mitigation Table for Sensor 1

| Sensor | Thermal Aggressor 1 | Thermal Aggressor 2 |
|---|---|---|
| 1 measured Temp. | Bin Setting | Bin Setting |
| T = 90 | P1 | P1 |
| T = 80 | P1 | P1 |
| T = 70 | P1 | P1 |
| T = 60 | P1 | P1 |
| T = 50 | P1 | P1 |
| T = 40 | P1 | P1 |
| T = 30 | P1 | P1 |
| T = 20 | P1 | P1 |

From the illustrative Default Mitigation Table for Sensor 1 above, in response to a temperature threshold of 60° C. being exceeded at Sensor 1, the JLPTM module may apply the default bin setting combination of P1 for both thermal aggressors. Consequently, the thermal energy being generated by the power consumption of the thermal aggressors will drastically reduce, thereby causing the temperature measured by Sensor 1 (as well as other monitored sensors) to drop. However, because setting the bin levels of the thermal aggressors to P1 may inevitably represent a more drastic power level reduction than necessary for maintaining the temperature measured by Sensor 1 at a level somewhere just below the thermal event temperature of 60° C., the temperature may drop quickly to levels below 60° C.

Returning to the example from the view of Sensor 1, once the temperature measured by the Sensor 1 stabilizes, the JLPTM module may recognize the reading as substantially equivalent to the ambient temperature to which the PCD is exposed. Notably, however, in some JLPTM embodiments, the ambient temperature may be determined from a measurement taken with a sensor associated with the ambient temperature, as opposed to deducing the ambient temperature in the way explained above. The JLPTM module may then systematically increment the bin settings of Thermal Aggressors 1 and 2 and measure the impact of their resulting increase in thermal energy generation on the temperature measurement at each sensor, including by Sensor 1. As the bin setting combinations are incremented, the JLPTM module may build a database of valid bin setting combinations for the thermal aggressors in association with the sensors, various target temperatures, the various thermal factor states such as the ambient temperature, and the time required for the PCD to hit various target temperatures and/or stabilize once a bin setting combination is applied. Advantageously, the valid bin setting combinations may be queried by the JLPTM module in future scenarios to identify an optimum bin setting combination, and the timing for its application, required to avoid a thermal event temperature from being reached.

From the valid bin setting combinations identified by the JLPTM module to stabilize the temperature measurement below the various target temperatures when the PCD is under the influence of certain thermal factors, the JLPTM module may select an optimum bin setting combination for each. The optimum bin setting combination may be selected based on its multi-correlation with the active aggressors' bin settings combination at the time of recognizing the potential for the thermal event as well as the relative closeness between the resulting stabilized temperature and the thermal event temperature seeking to be avoided. For instance, if Aggressor 1 is running at level P6 and Aggressor 2 is running at level P2 at the time of recognizing the potential of a thermal event happening, the JLPTM module may select an optimum bin setting combination that is close to the P6/P2 settings and set a timer for application of the optimum bin setting should no thermal factor state change cause the selection of the optimum bin setting and/or timing of its application to change. That is, if a valid bin setting combination has both Aggressors running at P3 while another valid bin setting combination has the Aggressors running at P5 and P2, respectively, then the JLPTM module may elect to apply the bin setting combination P5/P2 at some point in the future as it is closest to the P6/P2 setting that was active at the time of recognizing the potential for a certain thermal event to occur. In selecting an optimum bin setting combination in this manner, the JLPTM module may recognize that the active bin setting combination at the time of recognizing the potential for the thermal event to occur was driven by an ongoing use case and, as such, seek to select a new optimum bin setting combination from all valid bin setting combinations that is most likely to be compatible with the ongoing use case of the PCD.

Returning to the example, the default bin setting combinations in the mitigation table for the target temperature may then be replaced with the optimum bin setting combination. For illustrative purposes, the above Default Mitigation Table for Sensor 1 may be updated by the JLPTM module based on the iterative learning process describe above. Notably, a default mitigation table for other sensors may also be updated. The resulting Updated Mitigation Table for Sensor 1 may be:

Updated Mitigation Table for Sensor 1

| Sensor | Thermal Aggressor 1 | Thermal Aggressor 2 |
|---|---|---|
| 1 measured Temp. | Bin Setting | Bin Setting |
| T = 90 | P6 | P5 |
| T = 80 | P5 | P5 |
| T = 70 | P5 | P4 |
| T = 60 | P4 | P3 |
| T = 50 | P2 | P3 |
| T = 40 | P2 | P2 |
| T = 30 | P2 | P1 |
| T = 20 | P1 | P1 |

The JLPTM module may set a timer to apply the optimum bin setting combination, P4 for Thermal Aggressor 1 and P3 for Thermal Aggressor 2, at some time in the future if no thermal factor state changes in the meantime. By doing so, the JLPTM module may allow the PCD to continue running at the active bin settings for as long as possible while ensuring that the thermal energy levels measured by Sensor 1 will not exceed the thermal event temperature of 60° C. Notably, the optimum bin setting combination of P4 for Thermal Aggressor 1 and P3 for Thermal Aggressor 2 and the timing of its application may also have been selected by the JLPTM module based on a recognition that such bin setting combination would not cause thermal event temperatures associated with other sensors to be exceeded. Advantageously, in future scenarios where the JLPTM module receives notification that one of thermal factor combinations (bin settings, ambient temperature, workload/use case, etc.) learned in Updated Mitigation Table for Sensor 1 is being experienced by the PCD, a query of the table will inform the JLPTM module to apply the previously learned optimum bin setting combination at a certain time in the future to avoid the thermal event.

Also, because the Updated Mitigation Table for Sensor 1 includes optimum settings combinations for multiple thermal event temperatures at the determined thermal factor combinations which include the ambient temperature, one of ordinary skill in the art will recognize that the difference between a given stabilized temperature and the ambient temperature represents the amount of thermal energy measured by the sensor that is attributable to the thermal aggressors. With this recognition, the JLPTM module may “shift” the optimum bin setting combinations up or down the mitigation table when a change in ambient temperature is recognized.

For example, in the exemplary portion of the Updated Mitigation Table for Sensor 1 above, it can be seen that for a thermal event temperature of 20° C. the bin setting for both thermal aggressors should be set to P1 at some point. Therefore, in the example, the JLPTM module may deduce that the ambient environment temperature when the bin setting combinations were learned was also 20° C. Consequently, an expanded portion of the exemplary Updated Mitigation Table for Sensor 1 may include a column that indicates the thermal energy contribution attributable to each bin setting combination listed in the Updated Mitigation Table for Sensor 1:

Updated Mitigation Table for Sensor 1

| Sensor | Thermal | Thermal Aggressor | Thermal |
|---|---|---|---|
| 1 measured | Aggressor 1 | 2 | Aggressor Energy |
| Temp. | Bin Setting | Bin Setting | Contribution |
| T = 90° C. | P6 | P5 | 70° C. |
| T = 80° C. | P5 | P5 | 60° C. |
| T = 70° C. | P5 | P4 | 50° C. |
| T = 60° C. | P4 | P3 | 40° C. |
| T = 50° C. | P2 | P3 | 30° C. |
| T = 40° C. | P2 | P2 | 20° C. |
| T = 30° C. | P2 | P1 | 10° C. |
| T = 20° C. | P1 | P1 | 0° C. |

Returning to the example, the JLPTM module having selected and applied an optimum bin setting combination of P4 for Thermal Aggressor 1 and P3 for Thermal Aggressor 2 may work with a monitor module to monitor the rate at which the operating temperature approaches the thermal event temperature to build a heat dissipation curve associated with the settings.

Using the heat dissipation data, when the bin setting combination of P4 for Thermal Aggressor 1 and P3 for Thermal Aggressor 2 is used in future applications, the JLPTM module may expect the thermal energy to dissipate within a certain amount of time consistent with past learning and stabilize below the thermal event temperature. Notably, if the thermal event temperature is reached, the JLPTM module may deduce that the ambient environment to which the PCD is presently exposed is warmer than the ambient environment to which it was exposed when the selected optimum bin setting combination was learned (i.e., warmer than 20° C.). Similarly, if the operating temperature measured by the temperature sensor stabilizes at a temperature lower than expected or faster than expected, the JLPTM module may deduce that the ambient environment to which the PCD is presently exposed is cooler than the ambient environment to which it was exposed when the selected optimum bin setting combination was learned (i.e., cooler than 20° C.). Either way, embodiments of a JLPTM system and method may calculate the change in ambient temperature based on the known temperature contribution of the thermal aggressors (i.e., thermal aggressor energy contribution) associated with the selected optimum bin setting combination.

For example, in the above illustration the thermal aggressor energy contribution was calculated to be 40° C. when the bin setting combination was set to P4 for Thermal Aggressor 1 and P3 for Thermal Aggressor 2. As such, if the same bin setting combination results in an operating temperature measurement that is 70° C. (and all other thermal factors are held consistent), the JLPTM module may attribute the additional 10° C. to the ambient environment and update the mitigation table by “shifting” the optimum bin setting combinations up a level. In the example, shifting the bin setting combinations up a level in response to recognizing that the ambient temperature has increased from 20° C. to 30° C. will result in the following:

Second Iteration Updated Mitigation Table for Sensor 1

| Sensor | Thermal | Thermal Aggressor | Thermal |
|---|---|---|---|
| 1 measured | Aggressor 1 | 2 | Aggressor Energy |
| Temp. | Bin Setting | Bin Setting | Contribution |
| T = 90° C. | P5 | P5 | 60° C. |
| T = 80° C. | P5 | P4 | 50° C. |
| T = 70° C. | P4 | P3 | 40° C. |
| T = 60° C. | P2 | P3 | 30° C. |
| T = 50° C. | P2 | P2 | 20° C. |
| T = 40° C. | P2 | P1 | 10° C. |
| T = 30° C. | P1 | P1 | 0° C. |
| T = 20° C. | P1 | P1 | 0° C. |

The JLPTM module may continue to use the above Mitigation Table for selection and application of optimum bin setting combinations until a thermal factor state change not previously recognized triggers the need for more learning. Notably, although embodiments of a multi-correlative learning thermal management method may be described herein with reference to a single sensor, it is envisioned that the same or similar algorithm may be applied simultaneously, or sequentially, in association with other sensors within the PCD.

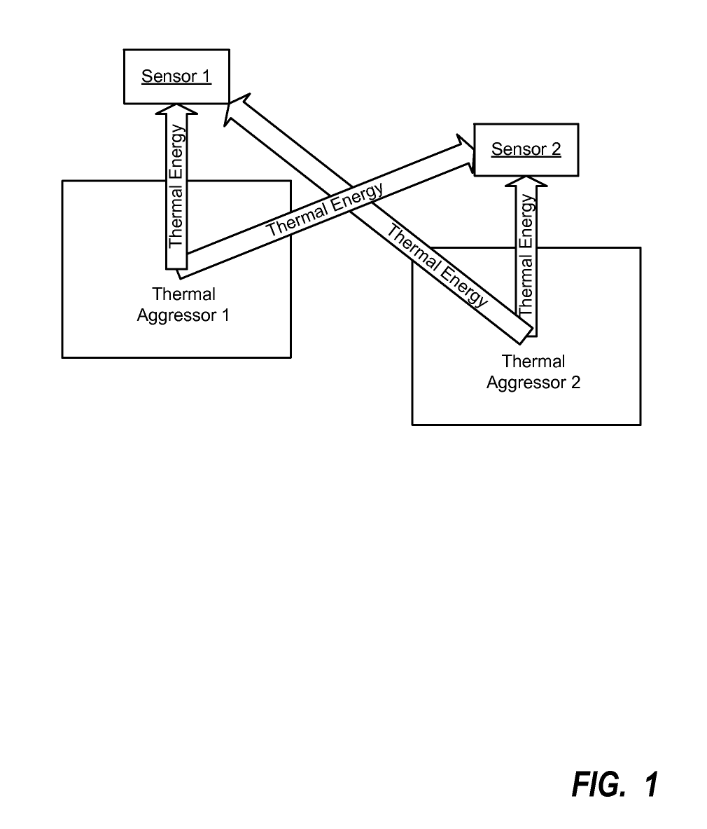

FIG. 1 is an illustration of exemplary thermal dynamics that may occur between multiple thermal aggressors and multiple temperature sensors in a system on a chip (“SOC”). As can be seen from the FIG. 1 illustration, thermal energy generated by both thermal aggressors may contribute to temperature readings taken by each of the thermal sensors. Notably, as one of ordinary skill in the art would recognize, a temperature reading taken by one of the sensors may be associated with a thermal event. As explained herein, embodiments of a JLPTM system or method may use past learning of thermal generation and dissipation in the PCD to recognize that a thermal event will occur and seek to avoid the thermal event by adjusting bin settings of the thermal aggressors just-in-time to cause the temperature to stabilize below the thermal event temperature.

Returning to the FIG. 1 illustration, because Sensor 1 in the illustration is closer to Thermal Aggressor 1, the thermal energy measured by Sensor 1 may be largely attributable to Thermal Aggressor 1. However, as one of ordinary skill in the art would recognize, Thermal Aggressor 2 may also generate thermal energy that affects the measurements taken by Sensor 1. Similarly, the thermal energy generated by Thermal Aggressor 1 may affect the temperature readings taken by Sensor 2, although perhaps not as much as the thermal energy generated by Aggressor 2 which is closer.

Even so, and as one of ordinary skill in the art would recognize, if Thermal Aggressor 2, for example, were set at a particularly low bin setting (therefore consuming relatively little power) and Thermal Aggressor 1 set at a relatively high bin level, the amount of thermal energy measured by Sensor 2 may be largely attributable to Thermal Aggressor 1 even though it is farther away from Sensor 2 on the chip than Thermal Aggressor 2. Advantageously, embodiments of the JLPTM systems and methods recognize the reality that various combinations of bin settings for multiple thermal aggressors may produce the same thermal energy measurement at a given sensor under the same operating and ambient conditions. By taking into account that multiple bin setting combinations may produce the same result, as measured by a given temperature sensor, a JLPTM module may select a specific bin setting combination that is best suited for an active use case and set a timer for its application should thermal factors affecting thermal generation and dissipation remain unchanged.

As mentioned above, embodiments of the JLPTM systems and methods recognize that thermal energy levels measured by sensors in an SOC, such as Sensor 1 and Sensor 2 in the FIG. 1 illustration, may be attributable to multiple thermal aggressors as well as the state of other thermal factors. Notably, the FIG. 1 illustration is offered for explanatory purposes only and is not meant to suggest that embodiments of a JLPTM system or method are limited to applying JLPTM solutions in applications that include only pairs of thermal aggressors and sensors. It is envisioned that embodiments of the systems and methods may be applicable to any combination of thermal aggressors and sensors that reside within a PCD.

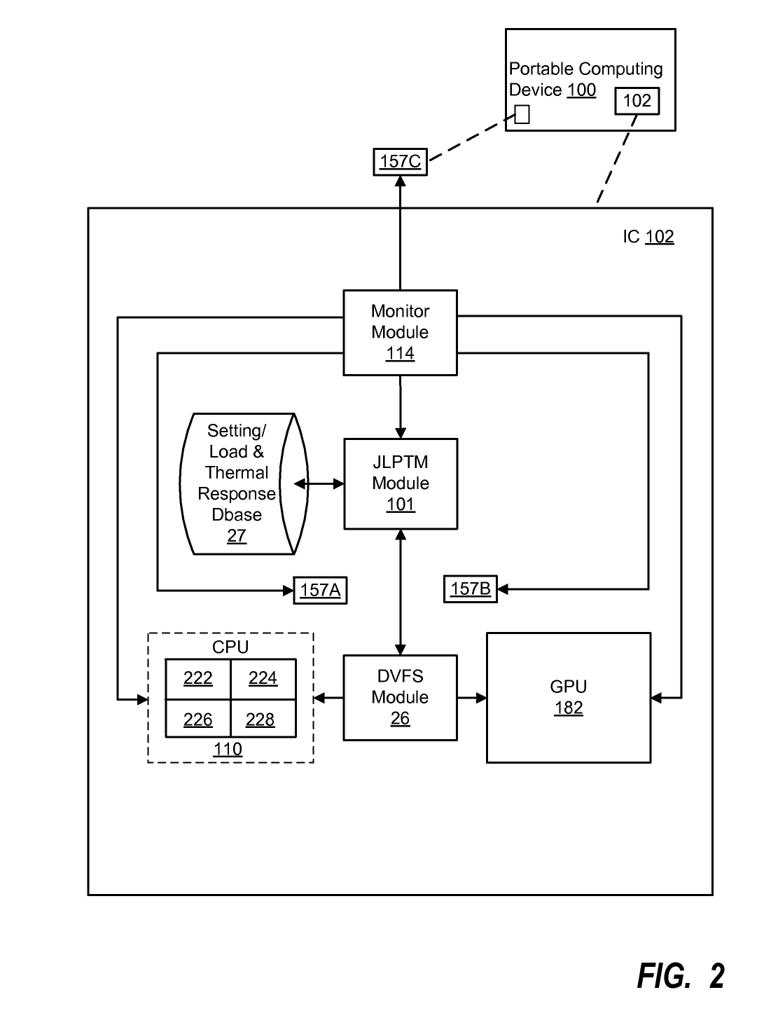

FIG. 2 is a functional block diagram illustrating an embodiment of an on-chip system 102 for implementing just-in-time learning-based predictive thermal management (“JLPTM”) methodologies in a PCD 100. A JLPTM system and method seeks to learn valid bin setting combinations for all thermal aggressor combinations on a chip that may cause temperatures measured by thermal sensors on the chip to stabilize and avoid a future thermal event. To do such, a JLPTM system and method recognizes changes in states for one or more thermal factors that influence thermal energy generation and dissipation in the PCD. In this way, a change in state for one or more thermal factors (such as processor bin settings, workload changes, ambient temperature changes, etc.) triggers a JLPTM system or method to analyze previously learned thermal behavior of the PCD and predict a future thermal event therefrom, such as a temperature reading that exceeds a critical temperature threshold. With knowledge of the future thermal event, a JLPTM system or method may proactively avoid the occurrence of the thermal event, as opposed to reacting to the probability of the event. Optimum bin setting combinations previously learned to cause the temperature to stabilize below the thermal event temperature are selected by the JLPTM module and, if no other thermal factor state change occurs, applied at a time in the future that allows for the thermal event to be avoided. By predicting a thermal event based on past learning, and delaying application of bin settings adjustments until it is inevitable that the thermal event will occur without the bin settings adjustments, an embodiment of a JLPTM system or method allows a PCD to run at its preferred bin settings for as long as possible without ramping them down to mitigate thermal energy generation, thereby optimizing QoS to the user.

In the FIG. 2 illustration, temperature sensors 157A and 157B are located on the chip 102 such that thermal energy measured by each may be attributable to energy produced by, and dissipated from, each of thermal aggressors GPU 182 and multi-processor CPU 110, which includes cores 222, 224, 226 and 228. Temperature sensor 157C is depicted as being “off-chip” and operable to detect ambient environment temperature. Notably, and as mentioned above, embodiments of a JLPTM methodology are not limited to applications of two thermal sensors and two thermal aggressors. It is envisioned that embodiments may accommodate far more complex multi-correlative environments where a plurality of thermal aggressors located around a chip may affect at various levels the temperatures measured by each of a plurality of temperature sensors. Moreover, one of ordinary skill in the art will recognize that embodiments of a JLPTM methodology is not limited in application to thermal aggressors in the form of CPUs and GPUs but, rather, may be applied to any combination of thermal aggressors such as, but not limited to, modems, display components, wireless LAN components, etc.

In general, the system 102 employs two main modules which, in some embodiments, may be contained in a single module: (1) just-in-time learning-based predictive thermal management (“JLPTM”) module 101 for analyzing temperature readings and/or thermal factor state changes monitored by a monitor module 114 (notably, monitor module 114 and JLPTM module 101 may be one and the same in some embodiments), predicting future thermal events, and determining and selecting optimum bin setting combinations that may be applied to the thermal aggressors at some future point in time to avoid a thermal event; and (2) a bin setting module such as, but not limited to, a DVFS module 26 for implementing incremental throttling strategies on individual processing components according to instructions received from JLPTM module 101.

Upon receiving a trigger from the monitor module 114 that a state change in a thermal factor has occurred, the JLPTM module 101 may determine from a query of Setting/Load & Thermal Response (“STR”) Database 27 that a future thermal event will likely occur without any further change to the thermal factor settings and that valid bin setting combinations have not previously been learned in association with the combination of thermal factor settings. If so, the JLPTM module 101 may trigger an iterative learning process that determines the ambient temperature of the PCD 100 (such as by reading temperature sensor 157C) and systematically identifies valid bin setting combinations and timing for applying those bin setting combinations in order to avoid the future thermal event just-in-time. From the valid bin setting combinations, the JLPTM module 101 may update records in the STR database 27 to include the optimum bin setting combinations and timing for their application to avoid a certain thermal event. In this way, the JLPTM module 101 may use the learned bin setting combinations in future scenarios that include thermal factor setting combinations that could result in the thermal event. The JLPTM module 101 may set a timer to trigger instruction of the dynamic voltage and frequency scaling (“DVFS”) module 26 to set the bins of the GPU 182 and CPU 110 (or certain cores 222, 224, 226, 228) at levels that, once applied, will mitigate thermal energy generation such that the predicted thermal event is avoided.

Using its knowledge of the heat dissipation rates of the various bin setting combinations in association with the thermal factor states, such as the ambient environment temperature, the JLPTM module 101 may be able to recognize an increase or decrease in the ambient temperature after application of a bin setting combination previously learned. Based on the extent of the increase or decrease in the temperature of the ambient environment to which the PCD 100 is exposed, the heat dissipation rate may not be acceptable to maintain a target QoS level. In such case, the JLPTM module 101 may iteratively determine new bin setting combinations for a given combination of thermal factors and then store them in the STR Database 27.

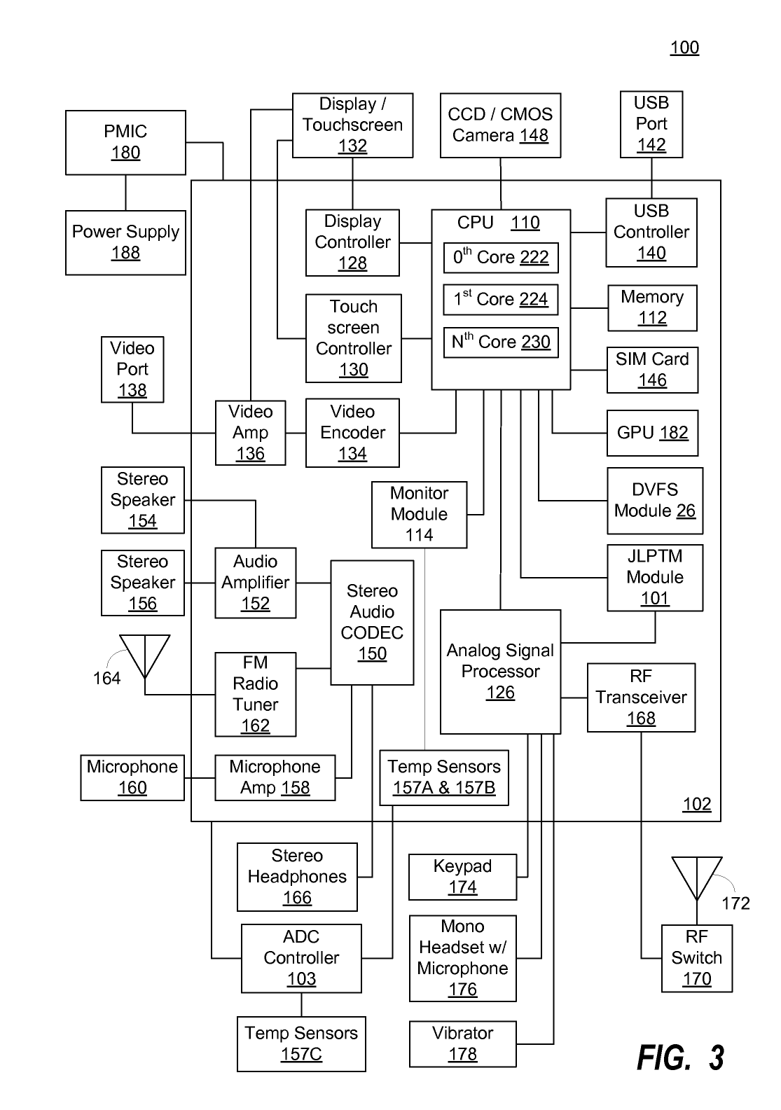

FIG. 3 is a functional block diagram illustrating an exemplary, non-limiting aspect of the PCD of FIG. 2 in the form of a wireless telephone for implementing methods and systems for just-in-time learning-based predictive thermal management (“JLPTM”). As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, the dynamic voltage and frequency scaling (“DVFS”) module 26 may be responsible for implementing throttling techniques to individual processing components, such as cores 222, 224, 230 in an incremental fashion to help a PCD 100 optimize its power level and maintain a high level of functionality without detrimentally exceeding certain temperature thresholds.

The monitor module 114 communicates with multiple operational sensors (e.g., thermal sensors 157A, 157B) distributed throughout the on-chip system 102 and with the CPU 110 of the PCD 100 as well as with the JLPTM module 101. In some embodiments, monitor module 114 may also monitor “off-chip” sensors 157C for temperature readings associated with a touch temperature of PCD 100. The JLPTM module 101 may work with the monitor module 114 to identify state changes in one or more thermal factors and, using JLPTM algorithms, instruct the application of throttling strategies to identified components within chip 102 in an effort to reduce the temperatures just-in-time before a thermal event occurs.

As illustrated in FIG. 3, a display controller 128 and a touch screen controller 130 are coupled to the digital signal processor 110. A touch screen display 132 external to the on-chip system 102 is coupled to the display controller 128 and the touch screen controller 130. PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core central processing unit (“CPU”) 110. A video amplifier 136 is coupled to the video encoder 134 and the touch screen display 132. A video port 138 is coupled to the video amplifier 136. As depicted in FIG. 3, a universal serial bus (“USB”) controller 140 is coupled to the CPU 110. Also, a USB port 142 is coupled to the USB controller 140. A memory 112 and a subscriber identity module (SIM) card 146 may also be coupled to the CPU 110. Further, as shown in FIG. 3, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 3, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 3 shows that a microphone amplifier 158 may also be coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 3 further indicates that a radio frequency (“RF”) transceiver 168 may be coupled to the analog signal processor 126. An RF switch 170 may be coupled to the RF transceiver 168 and an RF antenna 172. As shown in FIG. 3, a keypad 174 may be coupled to the analog signal processor 126. Also, a mono headset with a microphone 176 may be coupled to the analog signal processor 126. Further, a vibrator device 178 may be coupled to the analog signal processor 126. FIG. 3 also shows that a power supply 188, for example a battery, is coupled to the on-chip system 102 through PMIC 180. In a particular aspect, the power supply includes a rechargeable DC battery or a DC power supply that is derived from an alternating current (“AC”) to DC transformer that is connected to an AC power source.

The CPU 110 may also be coupled to one or more internal, on-chip thermal sensors 157A, 157B as well as one or more external, off-chip thermal sensors 157C. The on-chip thermal sensors 157 may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157 may comprise one or more thermistors. The thermal sensors 157 may produce a voltage drop that is converted to digital signals with an analog-to-digital converter (“ADC”) controller 103. However, other types of thermal sensors 157A, 157B, 157C may be employed without departing from the scope of the invention.

The DVFS module(s) 26 and JLPTM module(s) 101 may comprise software which is executed by the CPU 110. However, the DVFS module(s) 26 and JLPTM module(s) 101 may also be formed from hardware and/or firmware without departing from the scope of the invention. The JLPTM module(s) 101 in conjunction with the DVFS module(s) 26 may be responsible for applying throttling policies that may help a PCD 100 avoid thermal degradation while maintaining a high level of functionality and user experience.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, the power supply 188, the PMIC 180 and the thermal sensors 157C are external to the on-chip system 102. However, it should be understood that the monitor module 114 may also receive one or more indications or signals from one or more of these external devices by way of the analog signal processor 126 and the CPU 110 to aid in the real time management of the resources operable on the PCD 100.

In a particular aspect, one or more of the method steps described herein may be implemented by executable instructions and parameters stored in the memory 112 that form the one or more JLPTM module(s) 101 and DVFS module(s) 26. These instructions that form the module(s) 101, 26 may be executed by the CPU 110, the analog signal processor 126, or another processor, in addition to the ADC controller 103 to perform the methods described herein. Further, the processors 110, 126, the memory 112, the instructions stored therein, or a combination thereof may serve as a means for performing one or more of the method steps described herein.

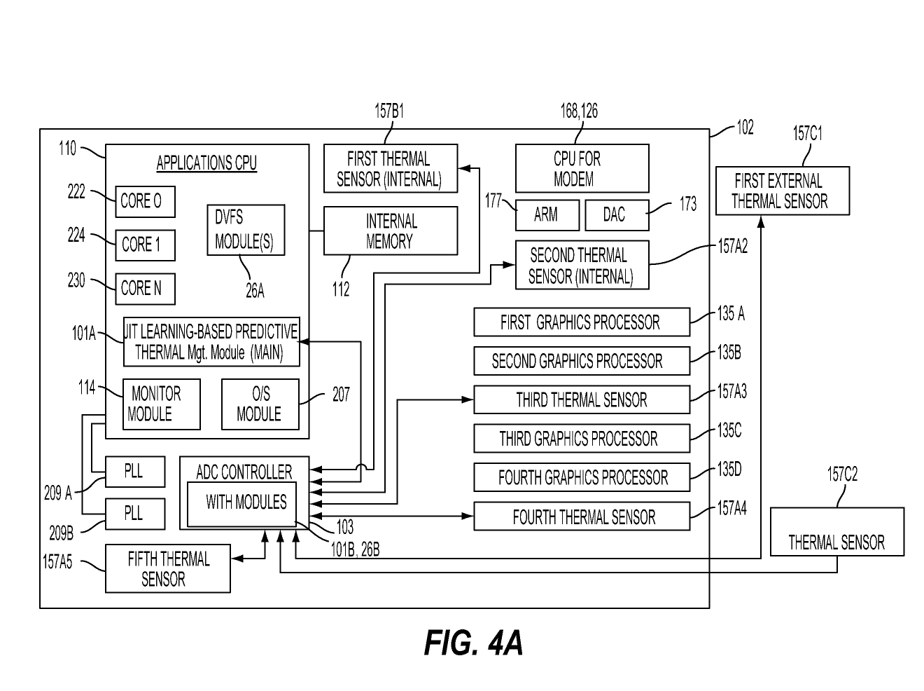

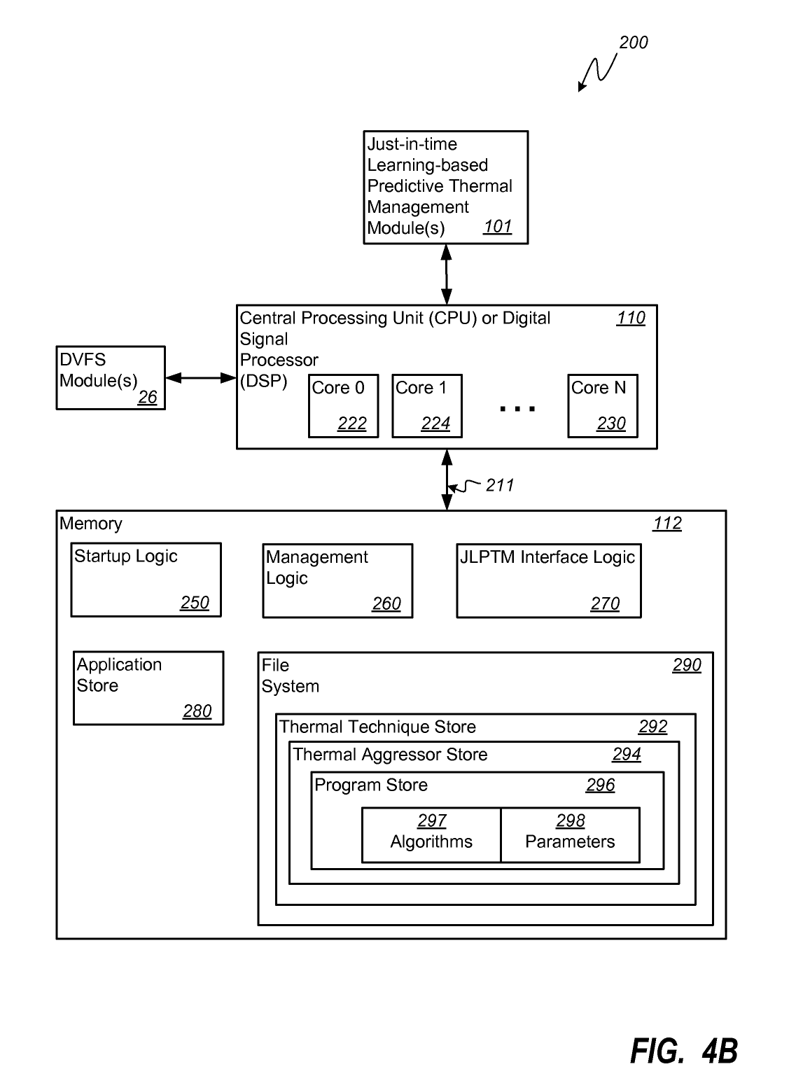

FIG. 4A is a functional block diagram illustrating an exemplary spatial arrangement of hardware for the chip 102 illustrated in FIG. 3. According to this exemplary embodiment, the applications CPU 110 is positioned on the far left side region of the chip 102 while the modem CPU 168, 126 is positioned on a far right side region of the chip 102. The applications CPU 110 may comprise a multi-core processor that includes a zeroth core 222, a first core 224, and an Nth core 230. The applications CPU 110 may be executing a JLPTM module 101A and/or DVFS module 26A (when embodied in software) or it may include a JLPTM module 101A and/or DVFS module 26A (when embodied in hardware). The application CPU 110 is further illustrated to include operating system (“O/S”) module 207 and a monitor module 114.

The applications CPU 110 may be coupled to one or more phase locked loops (“PLLs”) 209A, 209B, which are positioned adjacent to the applications CPU 110 and in the left side region of the chip 102. Adjacent to the PLLs 209A, 209B and below the applications CPU 110 may comprise an analog-to-digital (“ADC”) controller 103 that may include its own JLPTM module 101B and/or DVFS module 26B that works in conjunction with the main modules 101A, 26A of the applications CPU 110.

The on-chip or internal thermal sensors 157A, 157B may be positioned at various locations and associated with thermal aggressor(s) proximal to the locations (such as with sensor 157A3 next to second and third thermal graphics processors 135B and 135C) or temperature sensitive components (such as with sensor 157B1 next to memory 112). As noted above, however, although a given sensor may be physically proximate to a given thermal aggressor, the temperature measured by that sensor may be attributable to multiple thermal aggressors located around the chip 102. Moreover, the relative amount of thermal energy attributable to a given thermal aggressor and measured by a given thermal sensor may be a function of the bin setting of the thermal aggressor.

As a non-limiting example, a first internal thermal sensor 157B1 may be positioned in a top center region of the chip 102 between the applications CPU 110 and the modem CPU 168,126 and adjacent to internal memory 112. A second internal thermal sensor 157A2 may be positioned below the modem CPU 168, 126 on a right side region of the chip 102. This second internal thermal sensor 157A2 may also be positioned between an advanced reduced instruction set computer (“RISC”) instruction set machine (“ARM”) 177 and a first graphics processor 135A. A digital-to-analog controller (“DAC”) 173 may be positioned between the second internal thermal sensor 157A2 and the modem CPU 168, 126.

A third internal thermal sensor 157A3 may be positioned between a second graphics processor 135B and a third graphics processor 135C in a far right region of the chip 102. A fourth internal thermal sensor 157A4 may be positioned in a far right region of the chip 102 and beneath a fourth graphics processor 135D. And a fifth internal thermal sensor 157A5 may be positioned in a far left region of the chip 102 and adjacent to the PLLs 209 and ADC controller 103.

One or more external thermal sensors 157C may also be coupled to the ADC controller 103. The first external thermal sensor 157C1 may be positioned off-chip and adjacent to a top right quadrant of the chip 102 that may include the modem CPU 168, 126, the ARM 177, and DAC 173. A second external thermal sensor 157C2 may be positioned off-chip and adjacent to a lower right quadrant of the chip 102 that may include the third and fourth graphics processors 135C, 135D. Notably, one or more of external thermal sensors 157C may be leveraged to indicate the touch temperature of the PCD 100, i.e. the temperature that may be experienced by a user in contact with the PCD 100.

One of ordinary skill in the art will recognize that various combinations of bin settings for the processing components outlined above and depicted in the FIG. 4A illustration may affect the temperature measured by each of the various temperature sensors. Embodiments of JLPTM systems and methods recognize the interplay of thermal aggressors and temperature measurements around a chip and seek to optimize bin setting combinations of the thermal aggressors to efficiently manage thermal energy generation and optimize QoS.

One of ordinary skill in the art will recognize that various other spatial arrangements of the hardware illustrated in FIG. 4A may be provided without departing from the scope of the invention. FIG. 4A illustrates yet one exemplary spatial arrangement and how the main JLPTM and DVFS modules 101A, 26A and ADC controller 103 with its JLPTM and DVFS modules 101B, 26B may recognize thermal conditions that are a function of the exemplary spatial arrangement illustrated in FIG. 4A, analyze historical thermal transitional behavior and apply optimal bin settings just-in-time to prevent a detrimental thermal event.

FIG. 4B is a schematic diagram illustrating an exemplary software architecture of the PCD of FIG. 3 for just-in-time learning-based predictive thermal management (“JLPTM”). Any number of algorithms may form or be part of at least one thermal management policy that may be applied by the JLPTM module 101 when certain thermal factor state combinations are recognized, however, in a preferred embodiment the JLPTM module 101 works with the DVFS module 26 to incrementally apply voltage and frequency scaling policies to individual thermal aggressors in chip 102 including, but not limited to, cores 222, 224 and 230. From the incremental scaling efforts, the JLPTM module identifies valid combinations of bin settings for multiple thermal aggressors necessary to avoid thermal events in view of various thermal factor state combinations.

As illustrated in FIG. 4B, the CPU or digital signal processor 110 is coupled to the memory 112 via a bus 211. The CPU 110, as noted above, is a multiple-core processor having N core processors. That is, the CPU 110 includes a first core 222, a second core 224, and an N^{th} core 230. As is known to one of ordinary skill in the art, each of the first core 222, the second core 224 and the N^{th} core 230 are available for supporting a dedicated application or program. Alternatively, one or more applications or programs may be distributed for processing across two or more of the available cores.

The CPU 110 may receive commands from the JLPTM module(s) 101 and/or DVFS module(s) 26 that may comprise software and/or hardware. If embodied as software, the module(s) 101, 26 comprise instructions that are executed by the CPU 110 that issues commands to other application programs being executed by the CPU 110 and other processors.

The first core 222, the second core 224 through to the Nth core 230 of the CPU 110 may be integrated on a single integrated circuit die, or they may be integrated or coupled on separate dies in a multiple-circuit package. Designers may couple the first core 222, the second core 224 through to the N^{th} core 230 via one or more shared caches and they may implement message or instruction passing via network topologies such as bus, ring, mesh and crossbar topologies.

Bus 211 may include multiple communication paths via one or more wired or wireless connections, as is known in the art. The bus 211 may have additional elements, which are omitted for simplicity, such as controllers, buffers (caches), drivers, repeaters, and receivers, to enable communications. Further, the bus 211 may include address, control, and/or data connections to enable appropriate communications among the aforementioned components.

When the logic used by the PCD 100 is implemented in software, as is shown in FIG. 4B, it should be noted that one or more of startup logic 250, management logic 260, JLPTM interface logic 270, applications in application store 280 and portions of the file system 290 may be stored on any computer-readable medium for use by, or in connection with, any computer-related system or method.

In the context of this document, a computer-readable medium is an electronic, magnetic, optical, or other physical device or means that can contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where one or more of the startup logic 250, management logic 260 and perhaps the JLPTM interface logic 270 are implemented in hardware, the various logic may be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The memory 112 is a non-volatile data storage device such as a flash memory or a solid-state memory device. Although depicted as a single device, the memory 112 may be a distributed memory device with separate data stores coupled to the digital signal processor 110 (or additional processor cores).

The startup logic 250 includes one or more executable instructions for selectively identifying, loading, and executing a select program for managing or controlling the performance of one or more of the available cores such as the first core 222, the second core 224 through to the N^{th} core 230. The startup logic 250 may identify, load and execute a select JLPTM program. An exemplary select program may be found in the program store 296 of the embedded file system 290 and is defined by a specific combination of a performance scaling algorithm 297 and a set of parameters 298 that may include timing parameters, thermal factor state combinations, etc. The exemplary select program, when executed by one or more of the core processors in the CPU 110 may operate in accordance with one or more signals provided by the monitor module 114 in combination with control signals provided by the one or more JLPTM module(s) 101 and DVFS module(s) 26 to scale the performance of the respective processor core “up” or “down” to just-in-time avoid a predicted thermal event. In this regard, the monitor module 114 may provide one or more indicators of events, processes, applications, resource status conditions, elapsed time, thermal factor states, etc.

The management logic 260 includes one or more executable instructions for terminating a JLPTM program on one or more of the respective processor cores, as well as selectively identifying, loading, and executing a more suitable replacement program for managing or controlling the performance of one or more of the available cores. The management logic 260 is arranged to perform these functions at run time or while the PCD 100 is powered and in use by an operator of the device. A replacement program may be found in the program store 296 of the embedded file system 290 and, in some embodiments, may be defined by a specific combination of a performance scaling algorithm 297 and a set of parameters 298.

The replacement program, when executed by one or more of the core processors in the digital signal processor may operate in accordance with one or more signals provided by the monitor module 114 or one or more signals provided on the respective control inputs of the various processor cores to scale the performance of the respective processor core. In this regard, the monitor module 114 may provide one or more indicators of events, processes, applications, resource status conditions, elapsed time, temperature, etc in response to control signals originating from the JLPTM module 101.

The interface logic 270 includes one or more executable instructions for presenting, managing and interacting with external inputs to observe, configure, or otherwise update information stored in the embedded file system 290. In one embodiment, the interface logic 270 may operate in conjunction with manufacturer inputs received via the USB port 142. These inputs may include one or more programs to be deleted from or added to the program store 296. Alternatively, the inputs may include edits or changes to one or more of the programs in the program store 296. Moreover, the inputs may identify one or more changes to, or entire replacements of one or both of the startup logic 250 and the management logic 260. By way of example, the inputs may include a change to the available bin settings for a given thermal aggressor.

The interface logic 270 enables a manufacturer to controllably configure and adjust an end user's experience under defined operating conditions on the PCD 100. When the memory 112 is a flash memory, one or more of the startup logic 250, the management logic 260, the interface logic 270, the application programs in the application store 280 or information in the embedded file system 290 may be edited, replaced, or otherwise modified. In some embodiments, the interface logic 270 may permit an end user or operator of the PCD 100 to search, locate, modify or replace the startup logic 250, the management logic 260, applications in the application store 280 and information in the embedded file system 290. The operator may use the resulting interface to make changes that will be implemented upon the next startup of the PCD 100. Alternatively, the operator may use the resulting interface to make changes that are implemented during run time.

The embedded file system 290 includes a hierarchically arranged thermal technique store 292. In this regard, the file system 290 may include a reserved section of its total file system capacity for the storage of information for the configuration and management of the various parameters 298 and thermal management algorithms 297 used by the PCD 100. As shown in FIG. 4B, the store 292 includes a thermal aggressor store 294, which includes a program store 296, which includes one or more thermal management programs that may include a just-in-time learning-based predictive thermal management program.

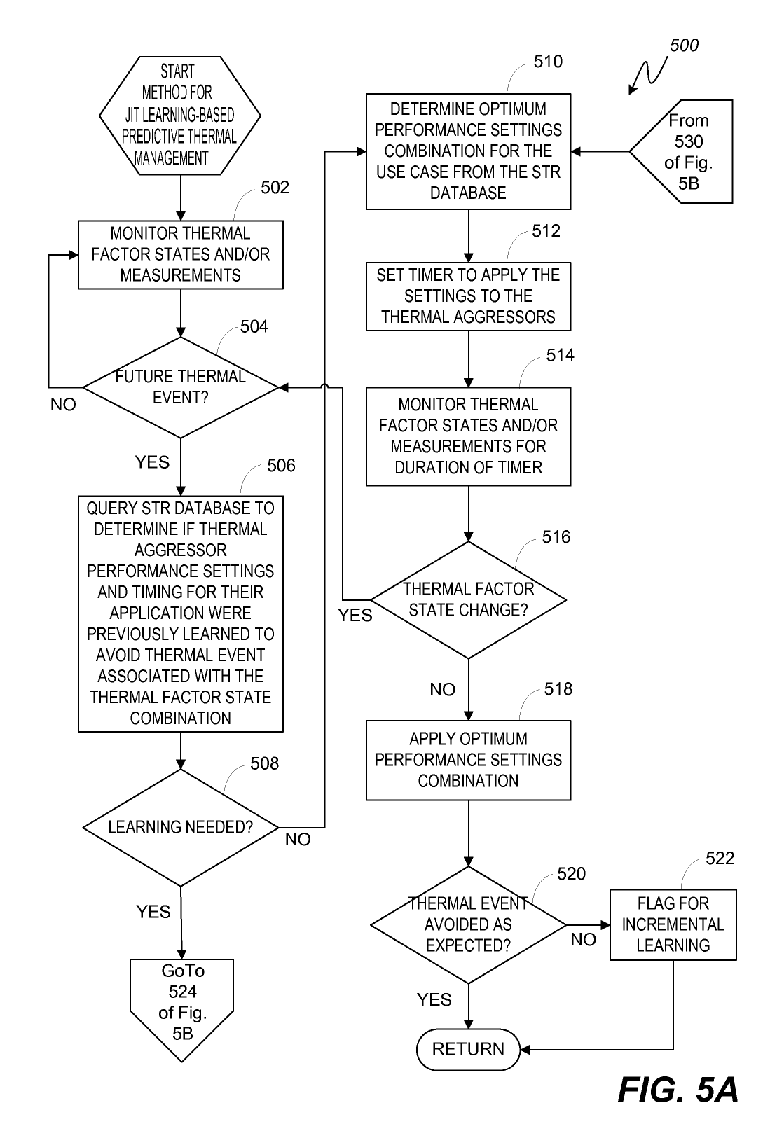

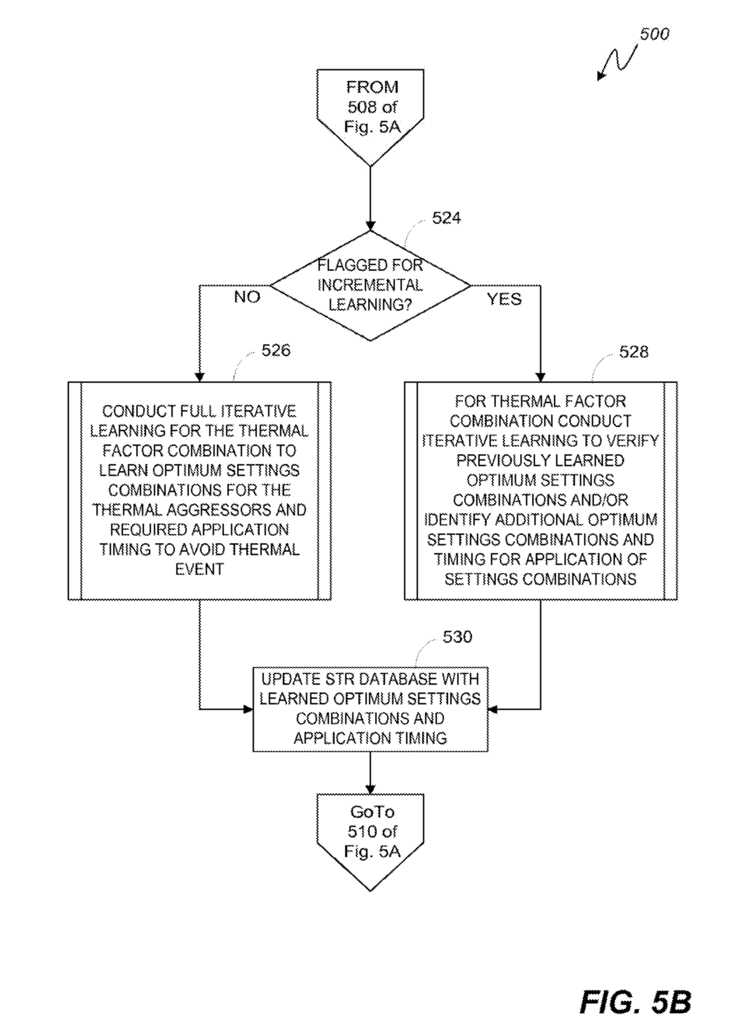

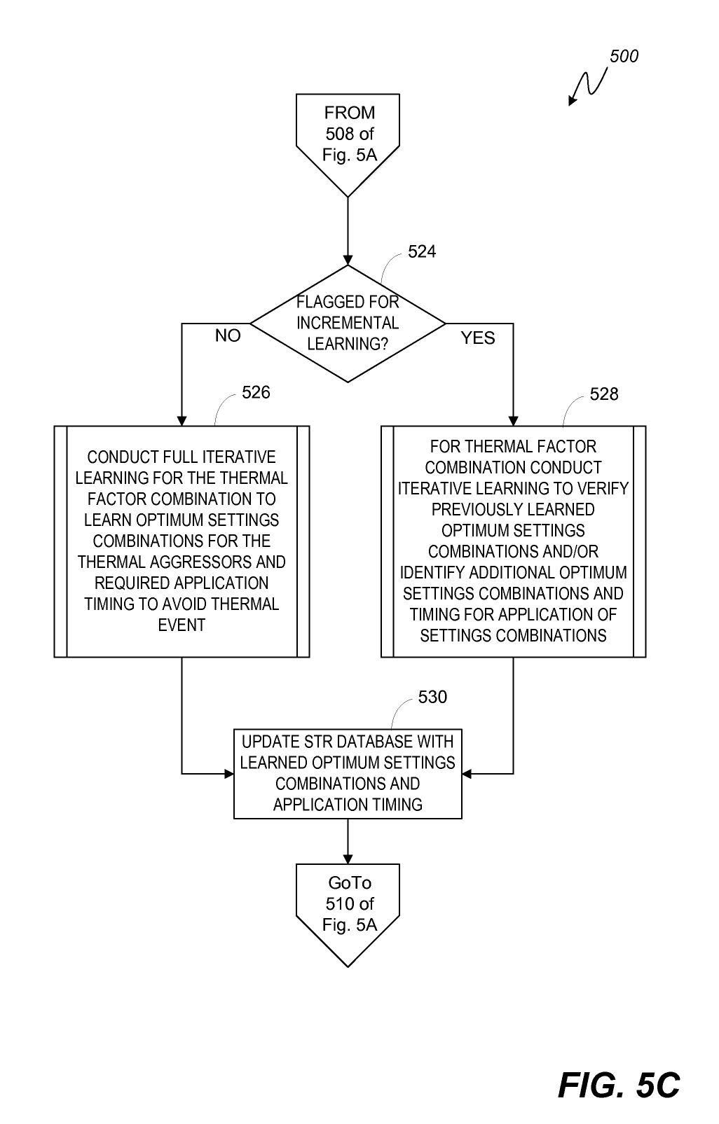

FIGS. 5A-5B are a logical flowchart illustrating a method 500 for managing thermal energy generation in the PCD of FIG. 2 through multi-correlative learning of the thermal dynamics between multiple thermal aggressors and multiple temperature sensors. Method 500 of FIG. 5 starts with a first block 502 in which one or more temperature sensors located around a chip and/or one or more thermal factors are monitored. Thermal factors are envisioned to include, but are not limited to including, device settings, ambient temperature, workload changes, etc. Temperature thresholds may have been previously set for each of the sensors. At block 504 a future thermal event may be predicted based on the particular combination of thermal factors recognized at block 502. If no future thermal event is predicted, the “no” branch is followed back to block 502. If at decision block 504 it is determined that the particular thermal factor combination will produce a future thermal envent, then the “yes” branch is followed to block 506. At block 506, the JLPTM module 101 may query the STR Database 27 to determine whether valid bin setting combinations and optimal timing for application to various thermal aggressors known to contribute to the eventual thermal event have been previously learned.

If learning is not required, i.e. valid bin setting combinations and optimal timing for application of those settings to avoid the predicted thermal event were previously learned, the “no” branch is followed to block 510. At block 510, an optimum bin setting combination is selected for application. Notably, the JLPTM module 101 may have previously learned, and stored in the STR Database 27 multiple valid bin setting combinations and timing for their respective applications in order to avoid the predicted thermal event detected at block 504. It is envisioned that the optimum bin setting combination selected from all the valid combinations previously learned may be associated, by multi-correlation, with the particular use case active at the time of the thermal event. For example, if the active use case were a gaming application, an optimum bin setting combination may include a bin setting for a GPU component that is high and a bin setting for a core in CPU 110 that is relatively low.

As an example, suppose a system that includes a CPU, a GPU and a modem running at bin settings of 1, 2, and 1, respectively. An active use case changes such that a request is made by a gaming application to increase the bin settings to 5, 4 and 3 respectively. Because the bin settings of the processing components are understood to be thermal factors that affect thermal energy generation in the PCD, a request to change the bin settings may trigger application of a JLPTM algorithm. The JLPTM module 101 may conclude that increasing the bin settings to 5, 4 and 3 will result in a thermal event at some point in the future. In response to the request, therefore, the JLPTM module may allow the increased bin settings but set a timer to apply alternative bin settings just-in-time to avoid the predicted thermal event. The alternative bin settings, or optimal bin setting combination, may be selected from a number of valid bin setting combinations which would each avoid the predicted thermal event. It is envisioned that the selected bin setting combination to apply at the end of the timer duration may be selected based on its closeness to the requested bin settings of 5, 4, 3.

Returning to the method 500, at block 512 a timer is set to dictate the optimal time for applying the optimum bin setting combination selected at block 510 should no further thermal factor state changes be detected. At block 514, the thermal factor states are monitored for the duration of the timer while the various thermal aggressors are allowed to run at preferred processing levels, thereby optimizing QoS delivered to the user during the timing duration. At decision block 516, if no thermal factor state changes were recognized during the timing duration, then it is assumed that the predicted thermal event will occur if the optimum performance settings determined at block 510 are not applied. The “no” branch is followed to block 518 and the optimum settings are applied such that the rate of thermal energy generation is mitigated and the thermal event avoided.

After application of the optimum performance settings combination, the thermal footprint of the PCD continues to be monitored and the thermal reaction to the adjusted performance settings compared to previous learning. At decision block 520, if the the thermal event is avoided and the thermal reaction is consistent with previous learning, then the “yes” branch is followed and the method 500 returns. If the thermal reaction was not as expected (for example, a temperature threshold was overshot before the temperature stabilized), the “no” branch is followed to block 522 and the bin settings combinations associated with the thermal factor state combination are flagged for incremental learning and updating. The method 500 returns.

Returning to decision block 516, if one or more thermal factors are changed during the timing duration, then the “yes” branch is followed back to decision block 504 where the new combination of thermal factor states is queried in the STR database 27 to determine if a future thermal event is likely. The method continues from block 504 as previously described.

Returning to decision block 508, if no performance bin settings combinations and application timing data have been previously learned in association with the thermal factor state combination, the “yes” branch is followed to decision block 524 of FIG. 5B. At decision block 524, the method 500 determines whether full learning of valid bin setting combinations and application timing data is needed for the thermal factor combination or existing bin setting combinations previously learned need incremental updating or verification.

If no valid bin setting combinations and application timing data is available in the SRT database 27 in connection with the thermal factor state combination, the method 500 follows the “no” branch to sub-routine 526. At sub-routine 526, a full iterative learning process is implemented such that valid bin setting combinations which would avoid the predicted thermal event are identified. Timing data for application of the valid bin settings combinations such that the predicted thermal event is avoided just-in-time is also imperically determined through the iterative process.

If existing bin setting combinations are flagged for verification or updating, the “yes” branch is followed from decision block 524 to sub-routine 528 and iterative learning or verification of timing data associated with previously learned bin setting combinations are updated. Moving from sub-routines 526, 528 the method 500 proceeds to block 530 where the new and/or updated bin setting combinations and timing data are stored in the SRT database 27 in association with the thermal factor combination. The method returns to block 510 of FIG. 5A.

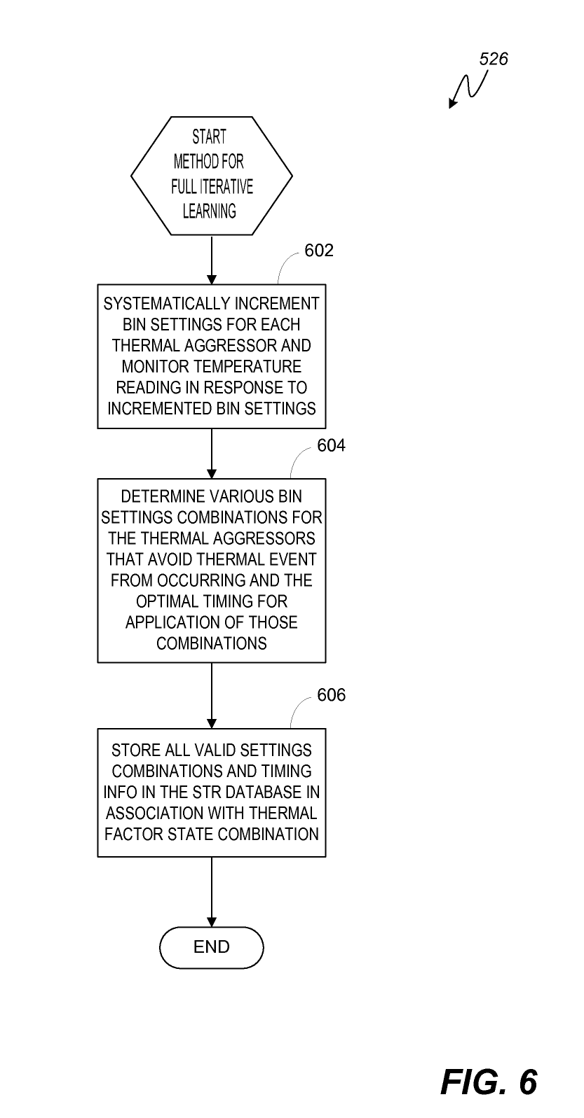

FIG. 6 is a logical flowchart illustrating a sub-method or subroutine 526 for an initial full iterative learning of the multi-correlative thermal dynamics between multiple thermal aggressors and multiple temperature sensors in association with a given thermal factor combination. Beginning at block 602, incremental increases of the bin settings for the various thermal aggressors are applied in an effort to find valid combinations of bin settings across all thermal aggressors that result in thermal energy generation levels that will not cause various temperature thresholds to be exceeded. After each increment of the bin settings, temperature and timing data is monitored and recorded to quantify thermal behavior of the PCD in response to the bin settings. As the bin setting combinations and timing for their applications are identified at block 604, at block 606 the combinations and timing are stored in association with the thermal factor state combination. Advantageously, the valid combinations of bin settings and timing data learned in this manner may be queried in the future for selection of a bin setting combination and timing of its application to avoid a thermal event just-in-time.

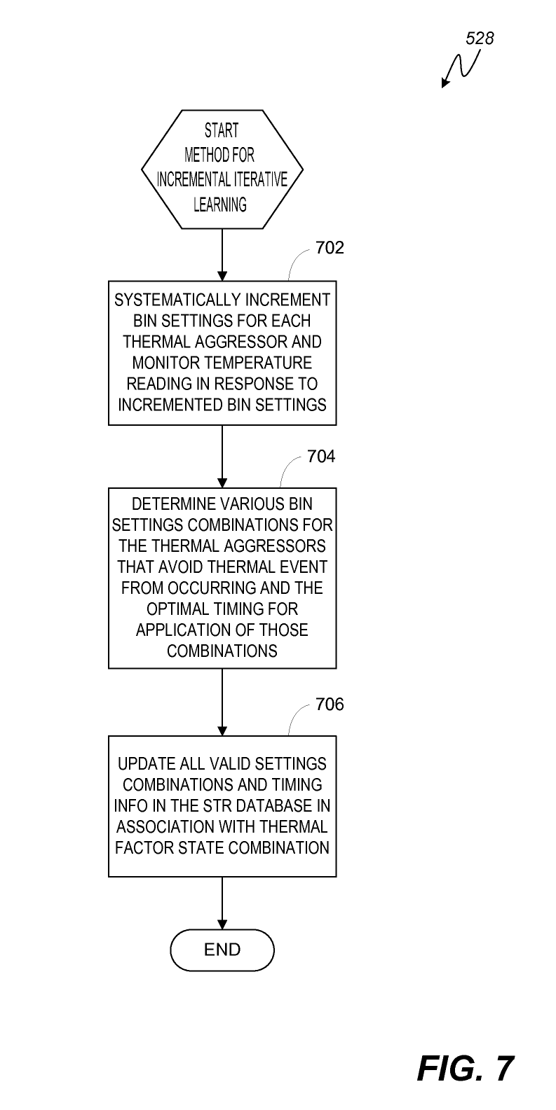

FIG. 7 is a logical flowchart illustrating a sub-method or subroutine 528 for an additional incremental iterative learning of the multi-correlative thermal dynamics between multiple thermal aggressors and multiple temperature sensors in association with a given target temperature. Beginning at block 702, incremental adjustments to previously learned bin settings for the various thermal aggressors are applied in an effort to verify valid combinations of bin settings across all thermal aggressors that result in thermal energy generation levels that will not cause various temperature thresholds to be exceeded. After each increment of the bin settings, temperature and timing data is monitored and recorded to quantify thermal behavior of the PCD in response to the bin settings. As the bin setting combinations and timing for their applications are identified at block 704, at block 706 the combinations and timing are updated in the STR database 27 in association with the thermal factor state combination. Advantageously, the valid combinations of bin settings and timing data learned in this manner may be queried in the future for selection of a bin setting combination and timing of its application to avoid a thermal event just-in-time.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, “subsequently” etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for predictive thermal management in a portable computing device (“PCD”), the method comprising:
monitoring a combination of thermal factors in the PCD, wherein each thermal factor contributes to a pattern of thermal behavior in the PCD;
recognizing that a value associated with one or more of the thermal factors in the combination has changed, resulting in a modified combination of thermal factors;
based on the modified combination of thermal factors, querying a database of historical thermal behavior data;
predicting that a thermal event will occur;
identifying an optimal bin setting combination for one or more thermal aggressors in the PCD that, if applied to the one or more thermal aggressors, is operable to mitigate thermal energy generation by the one or more thermal aggressors; and
setting a timer to trigger a future application of the optimal bin setting combination.

2. The method of claim 1, further comprising:
before the timer triggers application of the optimal bin setting combination, recognizing that a value associated with one or more of the thermal factors in the modified combination of thermal factors has changed;
predicting a second thermal event;
identifying a new optimal bin setting combination; and
resetting the timer.

3. The method of claim 1, wherein the value associated with one or more of the thermal factors is selected from a group comprised of a bin setting of the one or more thermal aggressors, an ambient temperature measurement, and a workload level.

4. The method of claim 1, wherein the optimal bin setting combination is identified based on an active bin setting combination.

5. The method of claim 1, further comprising applying the optimal bin setting combination when the timer expires, wherein applying the optimal bin setting combination prevents the predicted thermal event from occurring.

6. The method of claim 1, wherein the one or more thermal aggressors comprises a processing component selected from a group comprised of a graphical processing unit (“GPU”), a central processing unit (“CPU”), a digital signal processor (“DSP”), a video decoder, a display, and a wireless modem.

7. The method of claim 1, wherein the portable computing device is in the form of a wireless telephone.

8. A computer system for predictive thermal management in a portable computing device (“PCD”), the system comprising:
a just-in-time learning-based predictive thermal management (“JLPTM”) module, configured to:
monitor a combination of thermal factors in the PCD, wherein each thermal factor contributes to a pattern of thermal behavior in the PCD;
recognize that a value associated with one or more of the thermal factors in the combination has changed, resulting in a modified combination of thermal factors;
based on the modified combination of thermal factors, query a database of historical thermal behavior data;
predict that a thermal event will occur;
identify an optimal bin setting combination for one or more thermal aggressors in the PCD that, if applied to the one or more thermal aggressors, is operable to mitigate thermal energy generation by the one or more thermal aggressors; and
set a timer to trigger a future application of the optimal bin setting combination.

9. The computer system of claim 8, wherein the JLPTM module is further configured to:
before the timer triggers application of the optimal bin setting combination, recognize that a value associated with one or more of the thermal factors in the modified combination of thermal factors has changed;
predict a second thermal event;
identify a new optimal bin setting combination; and
reset the timer.

10. The computer system of claim 8, wherein the value associated with one or more of the thermal factors is selected from a group comprised of a bin setting of the one or more thermal aggressors, an ambient temperature measurement, and a workload level.

11. The computer system of claim 8, wherein the optimal bin setting combination is identified based on an active bin setting combination.

12. The computer system of claim 8, wherein the JLPTM module is further configured to apply the optimal bin setting combination when the timer expires, wherein applying the optimal bin setting combination prevents the predicted thermal event from occurring.

13. The computer system of claim 8, wherein the one or more thermal aggressors comprises a processing component selected from a group comprised of a graphical processing unit (“GPU”), a central processing unit (“CPU”), a digital signal processor (“DSP”), a video decoder, a display, and a wireless modem.

14. The computer system of claim 8, wherein the portable computing device is in the form of a wireless telephone.

15. A computer program product comprising a computer usable medium having a computer readable program code embodied therein, said computer readable program code adapted to be executed to implement a method for predictive thermal management in a portable computing device (“PCD”), said method comprising:
monitoring a combination of thermal factors in the PCD, wherein each thermal factor contributes to a pattern of thermal behavior in the PCD;
recognizing that a value associated with one or more of the thermal factors in the combination has changed, resulting in a modified combination of thermal factors;
based on the modified combination of thermal factors, querying a database of historical thermal behavior data;
predicting that a thermal event will occur;
identifying an optimal bin setting combination for one or more thermal aggressors in the PCD that, if applied to the one or more thermal aggressors, is operable to mitigate thermal energy generation by the one or more thermal aggressors; and
setting a timer to trigger a future application of the optimal bin setting combination.

16. The computer program product of claim 15, further comprising:
before the timer triggers application of the optimal bin setting combination, recognizing that a value associated with one or more of the thermal factors in the modified combination of thermal factors has changed;
predicting a second thermal event;
identifying a new optimal bin setting combination; and
resetting the timer.

17. The computer program product of claim 15, wherein the value associated with one or more of the thermal factors is selected from a group comprised of a bin setting of the one or more thermal aggressors, an ambient temperature measurement, and a workload level.

18. The computer program product of claim 15, wherein the optimal bin setting combination is identified based on an active bin setting combination.

19. The computer program product of claim 15, further comprising applying the optimal bin setting combination when the timer expires, wherein applying the optimal bin setting combination prevents the predicted thermal event from occurring.

20. The computer program product of claim 15, wherein the one or more thermal aggressors comprises a processing component selected from a group comprised of a graphical processing unit (“GPU”), a central processing unit (“CPU”), a digital signal processor (“DSP”), a video decoder, a display, and a wireless modem.
